(19) United States
(12) Patent Application Publication
(10) Pub. No.: US 2025/0146661 A1
(43) Pub. Date: May 8, 2025

(54) CANDLE

(71) Applicant: Liwei Huang, Shenzhen (CN)

(72) Inventor: Liwei Huang, Shenzhen (CN)

(21) Appl. No.: 18/542,899

(22) Filed: Dec. 18, 2023

(30) Foreign Application Priority Data
Nov. 7, 2023 (CN) 202322995769.9

(51) Int. Cl. F23D 3/16

(52) U.S. Cl. CPC F23D 3/16

(57) ABSTRACT

A candle includes a body and a wick. The body includes a cylinder and a plurality of raised ridges extending out of the cylinder from top to bottom. An upper end of the wick protrudes out from the top of the body, and the rest part thereof is embedded in the cylinder. When the candle burns, the raised ridges are melted slower than the center of the candle, there is a flame in the center of the top of the candle, and the peripheral raised ridges are in a shape of unfolded petals. In the burning process of the candle, the peripheral raised ridges are changed in lengths and shapes. Less vaporized and liquefied paraffin wax is produced during burning, and the flame is small, resulting in that the candle is consumed slowly and is cost-saving.

### CROSS-REFERENCE TO RELATED APPLICATIONS

The present application claims priority of China Patent Application No. 202322995769.9, filed on Nov. 7, 2023, the contents of which are incorporated herein by reference

### Background of the Invention

A candle is a common lighting tool widely used for decoration in the occasions of banquets, festivals, weddings or funerals, etc. The candle is mainly made of paraffin wax and generally has a flat bottom, a cylinder shape and a wick in the middle. The wick is usually made up of cotton thread. In actual use, when the wick at an upper end of a body of the candle is ignited, heat released by burning of the wick makes the solid paraffin wax melted and vaporized to generate paraffin wax vapor, and after the paraffin wax vapor is ignited, a relatively stable flame is formed. Existing candle shapes are relatively simple, and mostly cylindrical. When a candle burns, a concave pit is formed at the center of the cylindrical top of the candle to accommodate melted paraffin wax, resulting in that the candle flame is large and the candle is consumed fast.

### SUMMARY OF THE INVENTION

An objective of the present disclosure is to provide a candle that has a beautiful appearance and saves paraffin wax.

A candle, includes a wick and a body mainly composed of paraffin wax. The body includes a cylinder and a plurality of raised ridges extending out from a side surface of the cylinder from top to bottom. An upper end of the wick protrudes from the top of the body, and the rest part thereof is embedded in the cylinder.

The body of the candle includes the cylinder and the plurality of raised ridges extending out of the cylinder, thus looking beautiful in shape. When the candle burns, there is a flame in the center of the top of the candle, and the peripheral raised ridges are in a shape of unfolded petals, making the candle look pleasing. Furthermore, the cylinder at the center of the candle is smaller than that of a conventional candle, and the raised ridges are gradually away from the center, so that less vaporized and liquefied paraffin wax is produced during burning, and the flame is small, resulting in that the candle is consumed slowly and is cost-saving.

As an implementation, the cylinder is straight, and the plurality of raised ridges are rotationally and symmetrically arranged around the cylinder as an axis of symmetry. Due to a simple mold structure, it is easy and cost-effective to make this kind of candles.

As an implementation, the cylinder is straight, and the plurality of raised ridges are rotationally and symmetrically arranged around the cylinder as an axis of symmetry on any cross-section of the candle. Due to a simple mold structure, it is easy and cost-effective to make this kind of candles with beautiful appearances.

As an implementation, the candle further includes a base mainly composed of paraffin wax, and the cylinder extends upwards from the base. Arrangement of the base facilitates fixation of the candle.

As an implementation, the base is a cylindrical object with a regular shape, and its center of gravity is located on its central axis; and the cylinder extends along a curve from bottom to top, and the overall centers of gravity of the body and the wick are also located on the central axis. This kind of candles is more varied in shape and more beautiful.

As an implementation, on any cross-section of the candle, the raised ridges are rotationally and symmetrically arranged around the cylinder as an axis of symmetry. Due to a simple mold structure, it is easy and cost-effective to make this kind of candles with beautiful appearances.

As an implementation, a maximum width of the base is greater than that of the cylinder, so that the candle is more stable when placed vertically.

As an implementation, a cross-section of the base is polygonal, so that the candle can be conveniently separated from and fixed on a candlestick.

As an implementation, an outer edge of each raised ridge is curved, so that when the candle burns, the size of the candle and a flower pattern presented on the top of the body will change over time, thus making the candle have more ornamental value.

As an implementation, the body includes a plurality of layers from top to bottom, and adjacent layers have different colors, so that when the candle burns, colors of the flower pattern presented on the top of the body will change over time, thus making the candle have more ornamental value.

The body of the candle of the present disclosure includes the cylinder and the plurality of raised ridges extending out of the cylinder, thus looking beautiful in shape. When the candle burns, there is a flame in the center of the top of the candle, and the peripheral raised ridges are in a shape of unfolded petals, making the candle look pleasing. Furthermore, the cylinder at the center of the candle is smaller than that of a conventional candle, and the raised ridges are gradually away from the center, so that less vaporized and liquefied paraffin wax is produced during burning, and the flame is small, resulting in that the candle is consumed slowly and is cost-saving.

### BRIEF DESCRIPTION OF DRAWINGS

The foregoing and other exemplary purposes, aspects and advantages of the present invention will be better understood in principle from the following detailed description of one or more exemplary embodiments of the invention with reference to the drawings, in which:

FIG. 1 is a perspective view of a candle in a first embodiment.

FIG. 2 is a top view of the candle in FIG. 1.

FIG. 3 is a front view of a candle in a second embodiment.

FIG. 4 is a perspective view of a candle in a third embodiment.

FIG. 5 is a bottom view of the candle in FIG. 4.

FIG. 6 is a front view of a candle in a fourth embodiment.

### DETAILED DESCRIPTION OF THE INVENTION

The invention will now be described in detail through several embodiments with reference to the accompanying drawings.

### First Embodiment

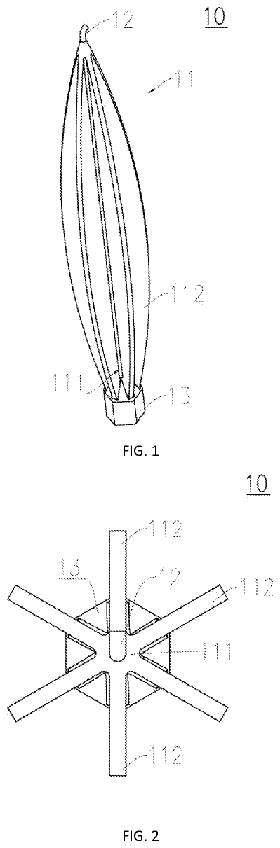

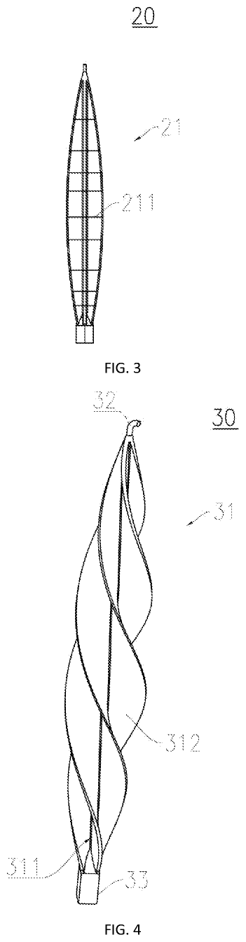

As shown in FIGS. 1 and 2, in a first embodiment, a candle 10 of the present disclosure mainly includes a body 11 and a wick 12. The body 11 is mainly made of paraffin wax, and includes a cylinder 111 and a plurality of raised ridges 112 extending out of the cylinder 111. Each of the raised ridges 112 further extends from one end of the cylinder 111 to the other end thereof along an outer surface (side surface) of the cylinder 111 from top to bottom.

An upper end of the wick 12 protrudes from the top of the cylinder 111 of the body 11, and the rest part thereof is embedded in the cylinder 111.

In this embodiment, the cylinder 111 is straight, hexagonal and cylindrical. Six raised ridges 112 extend out substantially vertically from six sides of the cylinder 111, and are rotationally and symmetrically arranged around the cylinder 111 as an axis of symmetry. Furthermore, on any cross-section of the candle, the plurality of raised ridges 112 are rotationally and symmetrically arranged around the cylinder 111 as an axis of symmetry, so that when viewed from the top of the body 11, the candle is shaped like a radial flower. When the candle burns, an arc-shaped concave pit is formed at the top of the candle; and when viewed from a side, the plurality of raised ridges 112 are higher on outer sides and shorter on inner sides with arc-shaped transition in the middle, resulting in that the candle overall looks like a flower in full bloom, thus having high ornamental value. Furthermore, the cylinder at the center of the candle is smaller than that of a conventional candle, and the raised ridges are gradually away from the center, so that less vaporized and liquefied paraffin wax is produced during burning, and the flame is small, resulting in that the candle is consumed slowly and is cost-saving.

In addition, the candle 10 further includes a base 13 mainly composed of paraffin wax, and the cylinder 111 extends upwards from an upper surface of the base 13. The base 13 is preferably a cylindrical object with a regular shape, and its center of gravity is located on its central axis. In this embodiment, the cross-section of the base 13 is hexagonal, and its maximum width is greater than the maximum width of the cylinder 111. The hexagonal and cylindrical base 13 can be conveniently fixed on a candlestick with hexagonal slots, so that the candle is more stable during use.

Furthermore, sizes of the raised ridges 112 extending outward along the outer surface of the cylinder 111 gradually change from top to bottom, that is, an outer edge of each raised ridge 112 is curved (relative to the surface of the cylinder). In this embodiment, when viewed from a front surface of the candle 10, the curved outer edge of each raised ridge 112 is in a shape of an arc that contracts from top to bottom and expands outward in the middle. Therefore, in the burning process of the candle, a flame changes from small to large and then from large to small.

In the first embodiment, when viewed from above the candle 10, thicknesses of all the raised ridges 112 are the same. It can be understood that in a variant of the first embodiment, each raised ridge 112 gradually becomes thicker from outside to inside, or is more shaped like a petal that is thick in the middle and thin on both sides.

In the first embodiment, the cylinder 111 is straight and cylindrical. It can be understood that in the variant of the first embodiment, the cylinder extends along a curve from bottom to top, and the overall centers of gravity of the body and the wick are located on the central axis of the base at the bottom. In this way, with a more beautiful appearance, the candle can be steadily arranged on a plane when it is in a vertical state. Preferably, in this case, on any cross-section of the candle, the raised ridges are rotationally and symmetrically arranged around the cylinder as an axis of symmetry.

### Second Embodiment

With reference to FIG. 3, a candle 20 in a second embodiment and the candle 10 in the first embodiment are basically the same in the shape and structure. The difference between the two candles lies in the fact that a body 21 is divided into a plurality of layers from top to bottom (a boundary of division between adjacent layers is marked as 211), and colors of the adjacent layers are different.

### Third Embodiment

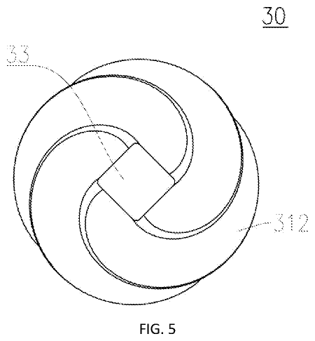

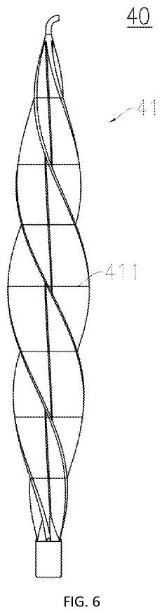

With reference to FIGS. 4 and 5, a candle 30 in the third embodiment and the candle 10 in the first embodiment are similar in the shape and structure, and the candle 30 includes a body 31 and a wick 32, where the body 31 is mainly made of paraffin wax, and includes a cylinder 311 and a plurality of raised ridges 312 extending out of the cylinder 311. Each of the raised ridges 312 further extends from one end of the cylinder 311 to the other end thereof along an outer surface of the cylinder 311 from top to bottom. In the third embodiment, the raised ridges 312 extend along the surface of the cylinder 311 from top to bottom in a curved manner, so that the raised ridges 312 are in a spiral rotation state as a whole. An upper end of the wick 32 protrudes from the top of the cylinder 311 of the body 31, and the rest part thereof is embedded in the cylinder 311.

In this embodiment, the cylinder 311 is straight, quadrilateral and cylindrical. Four raised ridges 312 basically extend out from four corners of the cylinder 311, and are rotationally and symmetrically arranged around the cylinder 311 as an axis of symmetry. Furthermore, on any cross-section of the candle, the plurality of raised ridges 312 are rotationally and symmetrically arranged around the cylinder 311 as an axis of symmetry.

The candle 30 further includes a base 33 mainly composed of paraffin wax, and the cylinder 311 extends upwards from an upper surface of the base 33. The base 33 is preferably a cylindrical object with a regular shape, and its center of gravity is located on its central axis. In this embodiment, the cross-section of the base 33 is quadrilateral, and its maximum width is greater than the maximum width of the cylinder 311. The quadrilateral and cylindrical base 33 can be conveniently fixed on a candlestick with quadrilateral slots, so that the candle is more stable during use.

Furthermore, sizes of the raised ridges 312 extending outward along the outer surface of the cylinder 311 gradually change from top to bottom, that is, an outer edge of each raised ridge 312 is curved (relative to the surface of the cylinder). In this embodiment, when viewed from a front surface of the candle 30, the curved outer edge of each raised ridge 312 is in a shape of an arc that contracts from top to bottom and expands outward in the middle. Therefore, in the burning process of the candle, a flame changes from small to large and then from large to small.

In the third embodiment, when viewed from above the candle 30, thicknesses of all the raised ridges 312 are the same. It can be understood that in a variant of the third embodiment, each raised ridge 312 gradually becomes thicker from outside to inside, or is more shaped like a petal that is thick in the middle and thin on both sides.

In the third embodiment, the cylinder 311 is straight, hexagonal and cylindrical. It can be understood that in the variant of the third embodiment, the cylinder extends along a curve from bottom to top, and the overall centers of gravity of the body and the wick are located on the central axis of the base at the bottom. In this way, with a more beautiful appearance, the candle can be steadily arranged on a plane when it is in a vertical state. Preferably, in this case, on any cross-section of the candle, the raised ridges are rotationally and symmetrically arranged around the cylinder as an axis of symmetry.

### Fourth Embodiment

With reference to FIG. 6, a candle 40 in the fourth embodiment and the candle 30 in Third embodiment are basically the same in the shape and structure. The difference between the two candles lies in the fact that a body 41 is divided into a plurality of layers from top to bottom (a boundary of division between adjacent layers is marked as 411), and colors of the adjacent layers are different.

In the description of the present disclosure, it is to be understood that the terms “upper”, “lower”, “front”, “back”, “left”, “right”, “vertical”, “horizontal”, “top”, “bottom”, “inner”, “outer”, etc. indicate azimuthal or positional relations based on those shown in the drawings only for ease of description of the present disclosure and for simplicity of description, and are not intended to indicate or imply that the referenced device or element must have a particular orientation and be constructed and operative in a particular orientation, and thus may not be construed as a limitation on the present disclosure.

In the present disclosure, unless otherwise explicitly specified and defined, the terms “mounting”, “connecting”, “connection”, “fixing”, etc. should be understood in a broad sense, for example, they may be a fixed connection, a detachable connection, or an integrated connection; may be a mechanical connection, or an electrical connection; may be a direct connection, or an indirect connection via an intermediate medium; and may be communication inside two elements, or an interactive relation between two elements. For those of ordinary skill in the art, the specific meanings of the terms described above in the present disclosure may be interpreted according to specific circumstances.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A candle, comprising:
a body mainly composed of paraffin wax, comprising:
a cylinder; and
a plurality of raised ridges extending out from a side surface of the cylinder from top to bottom; and
a wick, an upper end of which protruding out from a top of the body, and the rest part thereof being embedded in the cylinder.

2. The candle according to claim 1, wherein the cylinder is straight, and the plurality of raised ridges are rotationally and symmetrically arranged around the cylinder as an axis of symmetry.

3. The candle according to claim 1, wherein the cylinder is straight; the plurality of raised ridges are rotationally and symmetrically arranged around the cylinder as an axis of symmetry on any cross-section of the candle.

4. The candle according to claim 1, wherein the candle further comprises a base mainly composed of paraffin wax, and the cylinder extends upwards from the base.

5. The candle according to claim 4, wherein the base is a cylindrical object with a regular shape, and its center of gravity is located on its central axis; and the cylinder extends along a curve from bottom to top, and the overall centers of gravity of the body and the wick are also located on the central axis.

6. The candle according to claim 5, wherein on any cross-section of the candle, the raised ridges are rotationally and symmetrically arranged around the cylinder as an axis of symmetry.

7. The candle according to claim 4, wherein a maximum width of the base is greater than that of the cylinder.

8. The candle according to claim 7, wherein a cross-section of the base is polygonal.

9. The candle according to claim 1, wherein an outer edge of each raised ridge is curved.

10. The candle according to claim 1, wherein the body comprises a plurality of layers from top to bottom, and adjacent layers have different colors.
